(19) United States
(12) Patent Application Publication
(10) Pub. No.: US 2010/0133755 A1
(43) Pub. Date: Jun. 3, 2010

(54) LAYERED METALLIC GASKET

(76) Inventor: Angelo Fenaroli, Villongo (IT)

Correspondence Address: Robert Ruschena;R Ruschena Patent Agent, LLC, 8400 E Crescent Parkway, Suit 600, Greenwood Village, CO, 80111, US

(21) Appl. No.: 12/452,471

(22) PCT Filed: Jun. 19, 2008
(86) PCT No.: PCT/IT2008/000413

§ 371 Date: Jan. 2, 2010

(30) Foreign Application Priority Data
Jul. 12, 2007 (IT) TO2007A000519

(51) Int. Cl. F02F 11/00; B32B 38/04

(52) U.S. Cl. 277/313; 156/263; 277/592

(57) ABSTRACT

Head gasket (1) comprising a plurality of blades, or rather of circular crown shaped discs that are laid on top of one another according to an alternation of metal (2)—non metal (3), said blades kept together by arranging an adhesive between each pair of consecutive blades, characterised in that the adhesive is applied in spray form.

The object of the present finding is an innovative metallic head gasket, with high properties of seal and of maintaining the locking torque at high temperatures, and the relative production process.

In the state of the art numerous embodiments of metallic head gaskets are known. These are elements suitable for ensuring the to seal against fluids, be they liquids or gases, and they have numerous uses in mechanical components like valves, elements of machines, internal combustion engines and the like. They consist of a pack of many alternating layers of metal—non-metal held together by interpositioned layers of adhesive. For example, Japanese patent application JP 6081956 describes a head gasket for automobile engines consisting of a metallic layer, coated with a chrome-based layer, in turn coated with a rubber adhesive layer. The adhesive is protected by a further layer of heat-resistant rubber and by a layer of molybdenum disulfide, equipped with lubricating power. On the other hand, Japanese patent application JP 619137 has as its object a head gasket consisting of a metallic layer, coated with a rubber adhesive layer. The adhesive is then protected by a further layer of foamed rubber, the base polymer of which is the same as the adhesive layer.

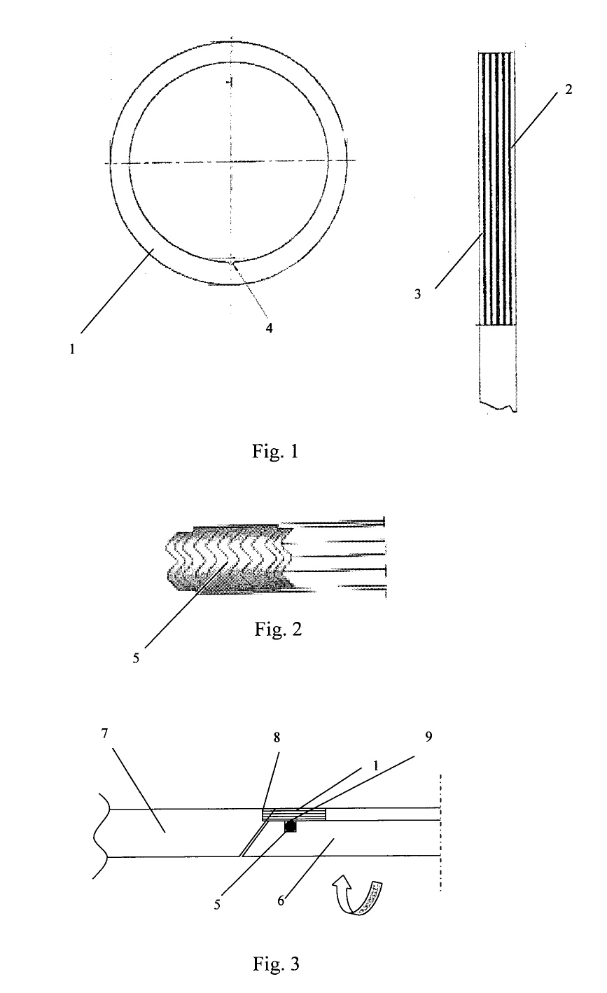

Head gaskets for valves, in particular butterfly valves, are very widely used: they consist of a series of metallic and non-metallic layers, in laminar (or circular crown) form, arranged alternately, where the base metal is a steel, preferably stainless, and the non-metallic material is graphite or polytetrafluoroethylene (PTFE) or similar. An example of metallic head gasket is represented in the two views of FIG. 1. A film of adhesive about 6-7 hundredths of a millimetre thick is arranged between the blades in contact, in order to avoid one slipping with respect to the next.

However, all known applications have a limitation in ensuring the seal at high temperatures. Such a limitation is set at around 200° C., since above these temperatures the adhesive film undergoes a softening that causes the gluing function to be lost, causing the slipping of the different blades, one with respect to the other, with consequent loss of seal of the entire pack. As the temperature increased the adhesive layer actually tends to dissolve losing weight and thickness. All of this consequently also leads to a reduction in the locking torque.

The purpose of the present finding is to define a head gasket and its production process that eliminate the aforementioned drawbacks allowing the use of gaskets at temperatures much higher than current ones.

According to another purpose, the present finding also defines a composition of the gasket that improves the seal in general, also at low temperatures.

The finding object of the present invention achieves the predetermined purposes as described in claim 1. It concerns a head gasket comprising a plurality of metallic and non-metallic circular crowns, alternating with one another, held together by means of an adhesive and characterised in that the adhesive is applied in spray form. In this way, no loss of thickness occurs when operating at high temperatures. Moreover, the finding uses high-density graphite as non-metallic material in order to reduce the porosity and consequently improve the sealing capability of o the gasket, also at low temperatures.

These and other advantages shall become clearer during the course of the detailed description of the invention than shall refer specifically to table 1/1 and in which a pair of preferred example embodiments of the present finding are represented, absolutely not for limiting purposes.

In particular:

FIG. 1 represents a view and a section of a head gasket according to the invention;

FIG. 2 shows the partial section of a second type of head gasket, known as a graphoil gasket;

FIG. 3 schematically shows an application of both of the gaskets of FIGS. 1 and 2.

A preferred example of head gasket (1) is the one represented in FIG. 1. It comprises a plurality of blades, or rather of circular crown shaped discs that are laid on top of one another according to an alternation of metal (2)—non-metal (3). The metallic blades (2) consist of steel, preferably stainless, whereas the non-metallic blades (3) are made from graphite or PTFE. According to a preferred embodiment, the graphite is of the high-density type, in particular greater than 1.5 g/cm³. The higher density ensures that the graphite has a low porosity, which prevents internal leaks and therefore improves the sealing capability of the gasket. The blades are kept together by arranging an adhesive between each pair of consecutive blades, characterised in that it is applied in spray form. This spray glue consists of a dispersion of natural rubber and resin in the following substances: naphtha (<50%), cyclohexane (<25%), liquefied propane gas (25%), isobutane (<25%) and acetone (<10%). The uniform application of spray glue does not create a thickness that is later subject to is dissolving with high temperatures. The gasket can therefore work at high temperatures without fear of a loss of seal and/or of locking torque.

The working process consists of the following steps. Firstly, the plate is cut, preferably with laser technology to make shapes that are not only circular but also of other types, then it is trimmed and roughed. In parallel, the graphite is cut. The layers of steel and of graphite are assembled by piling them up alternately one on top of the other and aligning them by means of a striker (4). Then comes the application of the glue that must be sprayed uniformly and, finally, the cold moulding is performed from which the end product is obtained.

The sealing gasket thus made is able to withstand high temperatures and positive experimental data is available for s temperatures of up to 430° C.

The use of high-density graphite also improves the seal of a second type of gasket, graphoil gaskets (5), an example of which is shown in FIG. 2. In this type of gasket the blades consist of a continuous strip of metallic material with special shaped profile—the example in the figures represents a double spiral—coupled with a continuous strip of high-density wound uniformly in a spiral with controlled speed in order to ensure an elastic return. These gaskets, given their elasticity, are particularly suitable for ensuring a perfect seal in variable temperature and pressure conditions, managing to maintain the seal by elastically recovering the linear excursions deriving from the expansion of the materials.

A practical application of both of the described gaskets is in butterfly valves to ensure the seal between disc of the butterfly (6) and seat (7) in closed conditions of the butterfly. As shown in FIG. 3, the two gaskets, the head gasket (1) and the graphoil gasket (5) act in combination, the first ensuring the radial seal (8) and the second ensuring the axial seal (9).

1. Head gasket comprising a plurality of blades, or rather of circular crown-shaped discs that are laid on top of one another according to an alternation of metal (2) and non-metal blades (3), said blades held together by arranging an adhesive between each pair of consecutive blades, said adhesive being a glue spray consisting of a dispersion of natural glue and resin in the following substances: <50% of naphtha, <25% of cyclohexane, 25% of liquefied propane gas, <25% of isobutane and <10% of acetone.

2. Gasket according to claim 1, where the metallic blades (2) consist of steel, preferably stainless, whereas the non-metallic blades (3) are made from graphite or polytetrafluoroethylene (PTFE).

3. Gasket according to claim 2, wherein the graphite is of hi-density type, particularly with a density greater than 1.5 g/cm³.

4. Process for manufacturing a head gasket, as defined in the previous claims, consisting of the following steps:
cutting the plate, preferably with laser technology;
trimming and roughing thereof;
cutting the graphite;
assembling the layers of steel and layers of graphite by piling them up alternately, one on top of the other, and aligning them by means of a striker (4);
applying the glue with uniform and homogeneous spray;
cold moulding.

5. Use of a head gasket, and a graphoil gasket, consisting of a continuous strip of metallic material and high-density graphite, wound uniformly in a spiral using a controlled speed, in a butterfly valve to ensure the seal between disc of the butterfly (6) and seat (7), wherein the two gaskets, the head gasket (1) and the graphoil gasket (5) act in combination, the first ensuring the radial seal (8) and the second ensuring the axial seal (9).
